(19) United States
(12) Patent Application Publication
(10) Pub. No.: US 2024/0246855 A1
(43) Pub. Date: Jul. 25, 2024

(54) METHODS FOR PRODUCING STUCCO COMPOSITIONS USEFUL IN MAKING GYPSUM PRODUCTS

(71) Applicants: CertainTeed Gypsum, Inc., Malvern, PA (US); Georgia Tech Research Corporation, Atlanta, GA (US)

(72) Inventors: Remi L. Goulet, Worcester, MA (US); Remi Lespiat, Devon, PA (US); Khoudor Keniar, Natick, MA (US); Kameron Michael Conforti, Charlotte, NC (US); Srinivas Garimella, Smyrna, GA (US); Jacob Tjards, Naperville, IL (US); Kristian Lockyear, Evansville, IN (US)

(21) Appl. No.: 18/515,518

(22) Filed: Nov. 21, 2023

Related U.S. Application Data
(60) Provisional application No. 63/480,986, filed on Jan. 22, 2023.

(51) Int. Cl. C04B 11/00; C04B 28/14; C04B 41/53

(52) U.S. Cl. CPC C04B 11/005; C04B 28/14; C04B 41/5307

(57) ABSTRACT

The present disclosure relates generally to methods for producing stucco compositions useful in making gypsum products. One aspect of the disclosure is a method for producing a stucco composition using dielectric calcination. Another aspect of the disclosure is a production process for a gypsum product using a stucco composition prepared by dielectric calcination.

### CROSS-REFERENCE TO RELATED APPLICATIONS

This application claims the benefit of priority of U.S. Provisional Patent Application No. 63/480,986, filed Jan. 22, 2023, which is hereby incorporated by reference in its entirety.

### STATEMENT OF GOVERNMENT INTEREST

This invention was made with Government support under Contract No. DE-0009394 awarded by the United States Department of Energy. The Government has certain rights in the invention.

### BACKGROUND OF THE DISCLOSURE

### 1. Field of the Disclosure

The present disclosure relates generally to methods for producing stucco compositions useful in making gypsum products.

### 2. Technical Background

Gypsum products (e.g., wallboard, ceiling board, drywalls, or plasterboards) are panels made of a gypsum core sandwiched between two layers of paper, often referred to as facing paper, on the outside surfaces of the gypsum core. They are widely used as construction materials due to their easy fabrication, strong mechanical strength, low thermal conductivity, and soundproofing properties. The quality of a gypsum product is strongly dependent on its gypsum core, which is fabricated by the hydration of a stucco material. The stucco material primarily contains calcium sulfate hemihydrate (CaSO₄·0.5H₂O), known colloquially as “stucco.” To make better gypsum products, a higher calcium sulfate hemihydrate content in the stucco material is desired to form a rigid interlocked gypsum crystal network in the gypsum core, and to facilitate control over the setting of the gypsum product.

However, real-world industrial stucco materials are always complex mixtures of calcium sulfates with different crystalline phases, typically including calcium sulfate dihydrate (CaSO₄·2H₂O, known colloquially as “gypsum”), calcium sulfate hemihydrate, soluble calcium sulfate anhydrate (CaSO₄), inert calcium sulfate (CaSO₄), and free moisture (H₂O). The variances in the stucco compositions can occur due to the use of raw gypsum materials from multiple resources, e.g., natural gypsum, flue gas desulfurization gypsum, or waste gypsum. Additionally, the conventional way of transforming raw gypsum materials into a stucco material is by calcining the raw gypsum materials in heated or burned natural gases. The operating conditions of the calcination can thus impact the final stucco composition. For example, when the calcination temperature is finely controlled between 110-120° C., calcium sulfate hemihydrates are formed in the final stucco composition. When the raw gypsum materials are insufficiently dehydrated, substantial amounts of calcium sulfate dihydrate remain in the final stucco composition. In contrast, when the raw gypsum materials are dried too much, fully dehydrated calcium sulfate phases (i.e., calcium sulfate anhydrite, at T=120-300° C.) and inert calcium sulfate (at T>300° C.) are observed.

Currently used calcination processes burn natural gas or use electric heating elements to heat the raw gypsum materials. This consumes about a third of the power used in the gypsum manufacturing process, and thus is a significant energy burden. Moreover, burning of natural gas relies heavily on fossil fuels and contributes to greenhouse gas emissions.

Accordingly, there remains a need for new methods of producing stucco compositions.

### SUMMARY OF THE DISCLOSURE

One aspect of the present disclosure is a method of producing a stucco composition. The method includes
providing a calcium sulfate feed comprising calcium sulfate dihydrate (gypsum); and
calcining the calcium sulfate feed using dielectric heating by exposing it to radio frequency radiation at a specific power of at least 15 W/kg calcium sulfate dihydrate in the feed, in a radio frequency range up to 900 MHz.

In some embodiments, at least 10 mol % of the calcium sulfate dihydrate of the calcium sulfate feed is converted to calcium sulfate hemihydrate (stucco). In some embodiments, at least 7% of crystalline water is removed from the calcium sulfate feed. In some embodiments, the exposure is performed for a duration that applies a specific energy dose of at least 0.0027 kW-hr/kg of calcium sulfate dihydrate in the feed.

Another aspect of the present disclosure is a production process for a gypsum product. The production process includes
providing a stucco composition by any method described herein;
hydrating the stucco composition in an aqueous slurry;
allowing the aqueous slurry to set; and
drying the set slurry to form the gypsum product.

Other aspects of the present disclosure will be apparent based on the description provided herein.

### BRIEF DESCRIPTION OF THE DRAWINGS

FIG. 1 is a schematic, cross-sectional view of a dielectric calcination system according to one embodiment of the present disclosure.

FIG. 2 is a diagram showing the mass loss of a gypsum sample from dielectric calcination under radio frequency radiation as a function of a specific energy of the radio frequency radiation.

FIG. 3 is a set of photographs of an experimental apparatus for dielectric calcination.

FIG. 4 is a diagram showing the temperature changes of the gypsum sample during dielectric calcination as a function of time.

FIG. 5 is a diagram showing the degree of calcination of the gypsum sample as a function of time.

FIG. 6 is a diagram showing the specific surface areas of the gypsum powder in the gypsum sample at different calcination stages during dielectric calcination.

FIG. 7 is a diagram showing the temperature changes of the dry and the wet gypsum samples during dielectric calcination as a function of time.

### DETAILED DESCRIPTION

Gypsum products can generally be prepared using a slurry formed from at least water and a stucco material. A person of ordinary skill in the art understands that the water-to-stucco ratio can significantly affect the processability of the slurry. For example, if the water-to-stucco ratio is too low, the fluidity of the slurry is also low, making the slurry less processable. In contrast, if the water-to-stucco ratio is too high, the benefits of increased fluidity are far outweighed by the increased energy cost required to dry the set gypsum product.

As discussed above, stucco materials are conventionally prepared by calcining raw gypsum materials using heat generated, for example, by burning natural gas or using an electrical heating element. The present inventors have determined that the mixing of water and the conventionally-prepared stucco material in combination with conventional additives can result in a slurry that has a low fluidity. Notably, the present inventors have determined that such a mixing can cause partial disintegration of the stucco particles in the stucco material. Accordingly, to make the slurry more processable, the person of ordinary skill in the art will increase the water-to-stucco ratio in the slurry. Although the excess water can be removed during the final drying step, typically a heating process in a gas-fired convection oven, this heating process undesirably increases the total energy consumption in the preparation of the gypsum product.

The present inventors have determined that use of dielectric heating in the calcination of a calcium sulfate feed can result in a number of advantages. For example, dielectric heating can avoid the conventional use of natural gas-fired heaters and can use green or otherwise renewable energy sources for the electricity used to power the radio frequency power source. And dielectric heating can be an especially efficient way to transfer electrical energy into the feed material as compared to use of electrically-powered heaters. This increased efficiency can be explained in part by the reduction of convective and conductive resistances that are present in the conventional heating process. Dielectric heating has the additional advantage of heating the material volumetrically as opposed to relying on surface heating and internal conduction through the gypsum. Especially at industrially relevant heating rates, this surface heating leads to significant temperature gradients within the gypsum, which can lead to over-calcination at the surface before the center is at a temperature where it can be calcined. Accordingly, use of dielectric heating can be especially environmentally friendly. Moreover, dielectric calcination of gypsum can provide a stucco material with a relatively high calcium sulfate hemihydrate content. The inventors also believe that the particles of the stucco material prepared by dielectric calcination are less apt to disintegrate when being mixed with water. This can allow the formation of a processable slurry with a relatively low water-to-stucco ratio, which means less heating is necessary to dry the board.

Accordingly, one aspect of the present disclosure is a method of producing a stucco composition using dielectric calcination. The method includes providing a calcium sulfate feed that includes calcium sulfate dihydrate (i.e., “gypsum”), and calcining that feed using dielectric heating by expositing to radio frequency radiation at a specific power of at least 15 W/kg calcium sulfate dihydrate in the feed, in a radio frequency range up to 900 MHz.

A variety of calcium sulfate feeds can be used. In various embodiments, the calcium sulfate feed comprises at least 60 wt % gypsum, e.g., at least 70 wt %, or at least 80 wt % or at least 90 wt % gypsum. Gypsum ores of the type used as feeds in conventional wallboard manufacture can be used in the processes of the disclosure. However, feeds with substantially less calcium sulfate dihydrate can be used. In some embodiments, the calcium sulfate feed includes at least 10 wt % gypsum, e.g., at least 25 wt % gypsum, or at least 40 wt % gypsum. The calcium sulfate feed can be, e.g., already partially calcined.

The person of ordinary skill in the art will, based on the disclosure herein, understand that the calcium sulfate feed may include free moisture, i.e., moisture that is not water of hydration of various crystalline substances like stucco and gypsum. In typical gypsum processing, this free moisture may be removed by drying, e.g., using a gas-fired oven, and then the resulting dried material is calcined. The present inventors have determined that in the methods described herein the presence of free moisture can accelerate dielectric calcination.

In some embodiments, the free moisture is present in the calcium sulfate feed in an amount up to 15 wt %, e.g., up to 10 wt %. As noted above, it can be desirable to have some free moisture present in the feed, as it can accelerate dielectric heating. Accordingly, in various embodiments, the free moisture is present in an amount in the range of 1-15 wt %, e.g., 1-10 wt %, or 2-15 wt %, or 2-10 wt %, or 3-15 wt %, or 3-10 wt %, or 4-15 wt %, or 4-10 wt %, or 5-15 wt %, or 5-10 wt %. Of course, a person of ordinary skill in the art can use various methods to provide calcium sulfate feeds with such free moisture contents. For example, a substantially more wet material (even in the form of a slurry) can be dried, e.g., by microwave heating, radio frequency heating, or gas-fired or electric oven to a lower free moisture content.

As the person of ordinary skill in the art will understand, only portions of the radio spectrum are reserved internationally for the use of radio frequency energy for industrial, scientific, and medical (ISM) purposes, excluding applications in telecommunications. Among those frequency ranges, only some, as shown below, are authorized in the United States for ISM purposes.

Frequency Ranges

| | |
|---|---|
| 6.765 MHz | 6.795 MHz |
| 13.553 MHz | 13.567 MHz |
| 26.957 MHz | 27.283 MHz |
| 40.66 MHz | 40.7 MHz |
| 902 MHz | 928 MHz |
| 2.4 GHz | 2.5 GHz |
| 5.725 GHz | 5.875 GHz |

It is possible to use other frequency ranges in the United States, but the shielding requirements are much higher. Other jurisdictions similarly have allowable frequency ranges.

Accordingly, the person of ordinary skill in the art can, based on the disclosure herein, determine a desired radio frequency range for the radio frequency radiation. In various desirable embodiments as otherwise described herein, the radio frequency range is up to 500 MHZ, e.g., no more than 450 MHz. In other embodiments, the radio frequency range is up to 100 MHZ, e.g., up to 50 MHz.

Further, in various desirable embodiments as otherwise described herein, the radio frequency range is in the range of 1-900 MHZ, e.g., in the range of 10-900 MHZ, or 20-900 MHZ, or 30-900 MHZ, or 35-900 MHZ. In some other embodiments, the radio frequency range is in the range of 1-500 MHZ, e.g., in the range of 10-500 MHZ, or 20-500 MHZ, or 30-500 MHz, or 35-500 MHZ, or 400-500 MHZ, or 430-500 MHZ, or 1-450 MHZ, or 10-450 MHZ, or 20-450 MHz, or 30-450 MHZ, or 35-450 MHZ, or 400-450 MHz, or 430-450 MHz. In some other embodiments, the radio frequency range is in the range of 430-436 MHZ, e.g., 432-436 MHz, or 433-435 MHz, or 433.05-434.79 MHz. In some other embodiments, the radio frequency range is in the range of 1-100 MHZ, e.g., in the range of 10-100 MHZ, or 20-100 MHz, or 30-100 MHZ, or 35-100 MHZ, or 1-50 MHz, or 10-50 MHz, or 20-50 MHz, or 30-50 MHz, or 35-50 MHz. In some other embodiments, the radio frequency range is in the range of 35-45 MHZ, e.g., in the range of 35-43 MHZ, or 35-42 MHZ, or 35-41 MHZ, or 37-45 MHZ, or 37-43 MHz, or 37-42 MHZ, or 37-41 MHz, or 39-45 MHZ, or 39-43 MHZ, or 39-42 MHZ, or 39-41 MHz, or 40-45 MHz, or 40-43 MHZ, or 40-42 MHZ, or 40-41 MHZ, or 40.66-40.7 MHz. In some other embodiments, the radio frequency range is in the range of 25-30 MHZ, e.g., in the range of 25-29 MHz, or 26-30 MHZ, or 26-29 MHz, or 26.957-28.283 MHz. In some other embodiments, the radio frequency range is in the range of 10-15 MHZ, e.g., in the range of 10-14 MHz, or 12-15 MHz, or 12-14 MHz, or 13-15 MHz, or 13-14 MHz, or in the range of 13.553-13.567 MHz. In still some other embodiments, the radio frequency range is in the range of 5-10 MHz, e.g., in the range of 6-10 MHZ, or 5-7 MHz, or 6-7 MHz, or 6.765-6.795 MHz.

Based on the disclosure herein, the person of ordinary skill in the art can also determine a desired specific power (i.e., power per unit mass of calcium sulfate dihydrate in the feed) for the radio frequency radiation. The person of ordinary skill in the art can tune the power depending on a variety of factors, including desired calcination rate, thermal surroundings, and size and shape of the mass of the feed to be calcined. In various embodiments as otherwise described herein, the specific power is at least 30 W/kg, e.g., at least 100 W/kg, or at least 200 W/kg, or at least 500 W/kg.

The person of ordinary skill in the art can also determine a desired specific energy dose (i.e., applied energy per unit mass of calcium sulfate dihydrate in the feed), depending on a number of factors including desired calcination rate, thermal surroundings and size and shape of the mass of the feed to be calcined. The person of ordinary skill in the art will appreciate that the theoretical specific energy dose for the conversion of calcium sulfate dihydrate to calcium sulfate hemihydrate is known to be about 0.027 kW-h/kg. Of course, this is a theoretical value, and energy losses in the overall system will often make the actual dose required to achieve a desired degree of calcination somewhat higher. In various desirable embodiments as otherwise described herein, the calcium sulfate feed is exposed to specific energy dose of at least 0.0027 kW·h/kg of calcium sulfate dihydrate in the feed, e.g., at least 0.005 kW·h/kg, or at least 0.01 kW·h/kg in the radio frequency range. In some other embodiments, the specific energy dose is at least 0.02 kW·h/kg of calcium sulfate dihydrate in the feed, e.g., at least 0.05 kW·h/kg, or at least 0.1 k·Wh/kg, or at least 0.2 kW·h/kg or at least 0.5 kW·h/kg in the radio frequency range. In still some other embodiments, the specific energy dose is no more than 3 kW·h/kg of calcium sulfate dihydrate in the feed, e.g., no more than 2 kW·h/kg, or no more than 1.5 kW·h/kg in the radio frequency range.

As noted above, during calcination, calcium sulfate dihydrate in a calcium sulfate feed is dehydrated to form calcium sulfate hemihydrate. Due to the loss of water, the mass of the calcium sulfate feed is reduced. If the calcium sulfate feed contains only dry calcium sulfate dihydrate, the mass loss is attributed to the loss of the water bound to the calcium sulfate crystals. The person of ordinary skill in the art can thus determine that the mass loss going from dihydrate to hemihydrate is about 15.7%. Thus, a theoretical calcium sulfate feed, if formed solely of calcium sulfate dihydrate and converted completely to the hemihydrate would have a mass of about 84.3% of the mass of the calcium sulfate feed.

However, the person of ordinary skill in the art will understand that the calcium sulfate feed may include components other than calcium sulfate dihydrate, such as free moisture and/or other materials, which can be inert to dehydration or dehydratable themselves. As used herein, inert materials are materials that do not contribute to the mass loss of the calcium sulfate feed during calcination. One example of an inert material is calcium sulfate anhydrite. There may also be dehydratable materials present, e.g., paper from recycled gypsum boards.

The person of ordinary skill in the art, depending on process requirements and any post-processing of the calcined material, will determine a desired degree of calcination. The dielectric heating methods described herein can be used to provide any desired degree of dehydration of dihydrate to hemihydrate. For example, in some embodiments, at least 10 mol % of the calcium sulfate dihydrate of the calcium sulfate feed is converted to calcium sulfate hemihydrate. For example, in some embodiments, at least 20 mol %, e.g., at least 30 mol %, or at least 40 mol % of the calcium sulfate dihydrate of the calcium sulfate feed is converted to calcium sulfate hemihydrate. In various embodiments, at least 50 mol %, e.g., at least 60 mol % of the calcium sulfate dihydrate of the calcium sulfate feed is converted to calcium sulfate hemihydrate. In various embodiments, at least 70 mol %, e.g., at least 80 mol % of the calcium sulfate dihydrate of the calcium sulfate feed is converted to calcium sulfate hemihydrate.

The degree of calcination can also be quantified by the amount of crystalline water removed from the calcium sulfate feed. In some embodiments, at least 5% of crystalline water, e.g., at least 7% of crystalline water is removed from the calcium sulfate feed. In some embodiments, at least 10% of crystalline water, e.g., at least 15% of crystalline water, or at least 20% of crystalline water is removed from the calcium sulfate feed. In some embodiments, at least 25% of crystalline water, e.g., at least 30% of crystalline water, at least 35% of crystalline water, or at least 40% of crystalline water is removed from the calcium sulfate feed. In some embodiments, at least 45%, e.g., at least 50% of crystalline water, at least 55% of crystalline water, at least 60% of crystalline water, or at least 65% of crystalline water is removed from the calcium sulfate feed.

However, in many embodiments it is undesirable to remove all crystalline water, as it is the hemihydrate that is the desired active species for formation of set gypsum materials. To make better gypsum products, the stucco material is desired in many embodiments to have a relatively high calcium sulfate hemihydrate content. Therefore, to prevent calcium sulfate dihydrate from complete dehydration into calcium sulfate anhydrite, the person of ordinary skill in the art will understand and appreciate that the calcination should be limited as much as possible to prevent over-calcination to the anhydrite or other further dehydrated species. Accordingly, in various embodiments, no more than 75% of crystalline water is removed from the calcium sulfate feed, e.g., no more than 74%, or no more than 73%.

Degree of calcination can also be quantified by mass loss of the calcium sulfate feed. In various embodiments as otherwise described herein, calcining reduces the mass of the calcium sulfate feed to provide a stucco composition having a mass of no more than 95% of the mass of the calcium sulfate feed, e.g., no more than 93%, no more than 92%, or no more than 90% of the mass of the calcium sulfate feed. In various embodiments as otherwise described herein, calcining reduces the mass of the calcium sulfate feed to provide a stucco composition having a mass of no more than 88% of the mass of the calcium sulfate feed, e.g., no more than 87%, no more than 86% of the mass of the calcium sulfate feed. In some embodiments, the calcining reduces the mass of the calcium sulfate feed to provide a stucco composition having a mass of no more than 85% of the mass of the calcium sulfate feed, e.g., no more than 84%, no more than 83%, or no more than 82% of the mass of the calcium sulfate feed. In some other embodiments, the calcining reduces the mass of the calcium sulfate feed to provide a stucco composition having a mass of no more than 81% of the mass of the calcium sulfate feed, e.g., no more than 80%, no more than 79%, or no more than 78% of the mass of the calcium sulfate feed. In still some other embodiments, the calcining reduces the mass of the calcium sulfate feed to provide a stucco composition having a mass in the range of 75-95% of the mass of the calcium sulfate feed, e.g., 75-93%, or 75-92%, or 75-90%, or 75-88%, or 75-87%, or 75-86%, or 75-85%, or 75-84%, or 75-83%, or 75-82%, or 75-81%, or 75-80%, or 75-79%, or 75-78%, or 77-95%, or 77-93%, or 77-92%, or 77-90%, or 77-88%, or 77-87%, or 77-86%, or 77-85%, or 77-84%, or 77-83%, or 77-82%, or 77-81%, or 77-80%, or 77-79%, or 80-95%, or 80-93%, or 80-92%, or 80-90%, or 80-88%, or 80-87%, or 80-86%, or 80-85%, or 80-84%, or 80-83%, or 80-82% of the mass of the calcium sulfate feed.

As the person of ordinary skill in the art will understand, a calcination time can affect the degree of calcination. For example, a sufficiently long calcination time can not only allow free moisture to be removed from the calcium sulfate feed, but also allow the dehydration process to occur and to complete. In contrast, if the calcination time is too short, there may not be enough energy imparted to system to allow the water to evaporate it or enough time for the water to escape from the calcium sulfate feed, and even if there is, the short calcination time may not allow the dehydration to occur or to complete. Accordingly, the person of ordinary skill in the art can, based on the disclosure herein, determine a desirable calcination time for calcining the calcium sulfate feed, especially in view of the power applied. In various desirable embodiments as otherwise described herein, the calcining is performed for a time of at least 5 seconds, e.g., at least 10 seconds, or at least 30 seconds, or at least 1 minute, or at least 5 minutes, or at least 10 minutes, or at least 30 minutes. In other embodiments, the calcining is performed for a time in the range of 10 seconds-120 minutes, e.g., 10 seconds-90 minutes, or 10 seconds-60 minutes. But the person of ordinary skill in the art will appreciate that other times can be used.

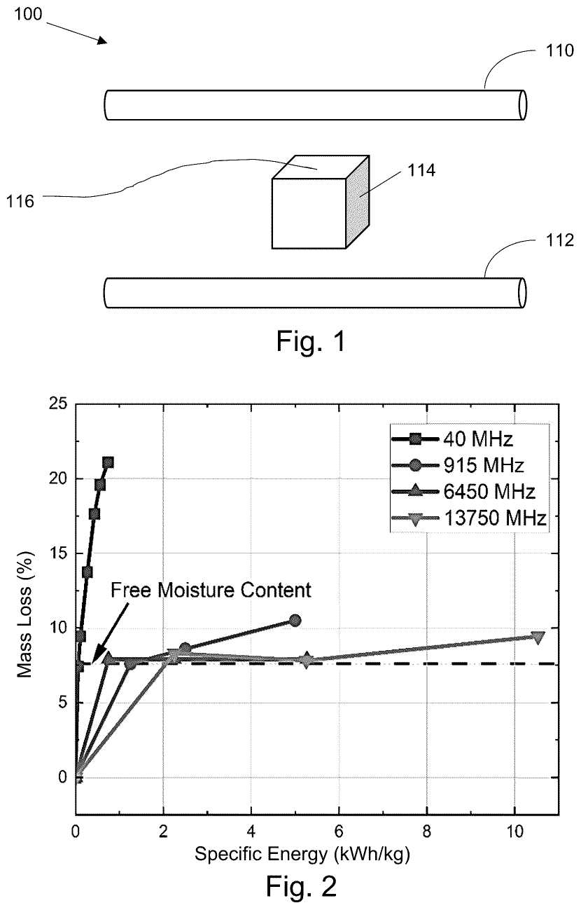

In various desirable embodiments as otherwise described herein, a dielectric calcination system can be used for calcining the calcium sulfate feed. One embodiment of the dielectric calcination system according to the present disclosure is shown in a schematic, cross-sectional view of FIG. 1. In this embodiment, the dielectric calcination system 100 includes a first electrode 110, a second electrode 112 spaced apart from the first electrode 110, and a sample holder 114 situated between the first electrode 110 and the second electrode 112. The sample holder 114 is configured to receive a calcium sulfate feed therein. The first electrode 110 and the second electrode 112 are electrically connected and configured to generate an alternating electric field there between. When the dielectric calcination system 100 is in operation, the calcium sulfate feed is exposed to a radio frequency radiation under the influence of the alternating electric field. The radio frequency radiation may cause any free moisture to be removed from the calcium sulfate feed, and also cause the calcium sulfate dihydrate in the calcium sulfate feed to dehydrate to form a stucco composition that primarily includes calcium sulfate hemihydrate. In some embodiments, the dielectric calcination system 100 may further include an optical fiber 116 at least partially embedded in the calcium sulfate feed and configured to measure the temperature of the calcium sulfate feed during calcination. Continuous processing can optionally be used in the methods of the disclosure. For example, the sample holder can include a conveyor belt on which a calcium sulfate feed is disposed, and moved through the space between the electrodes, e.g., at a rate such that the desired dose of radio frequency energy is imparted to the calcium sulfate feed.

Another aspect of the present disclosure is a production process for a gypsum product. The production process includes providing a stucco composition by the method described above. The production process also includes hydrating the stucco composition in an aqueous slurry, allowing the aqueous slurry to set, and drying the set slurry to form the gypsum product. The person of ordinary skill in the art can use conventional methods in the formation of such gypsum products which can be, for example, in the form of building boards. A building board can include a body of set gypsum between opposed liners of, e.g., paper or fiberglass.

### Examples

The Examples that follow are illustrative of specific embodiments of the present disclosure. They are set forth for explanatory purposes only, and are not to be taken as limiting the scope of the disclosure.

### Dielectric Calcination of a Gypsum Sample

This Example describes the dielectric calcination of a gypsum sample using radio frequency radiation having different radio frequencies, such as 40 MHz, 915 MHZ, 6450 MHz, or 13750 MHz. The specific energy of the radio frequency radiation ranged from 0-10 kW·h/kg. The sample sizes were about 10 g.

FIG. 2 is a diagram showing the mass loss of the gypsum samples from dielectric calcination as a function of specific energy of the radio frequency radiation. FIG. 2 shows that calcining the gypsum sample at or above 915 MHz could effectively remove the free moisture in the gypsum sample, but crystalline water was relatively unaffected. In contrast, FIG. 2 suggests that calcining using radio frequency radiation at 40 MHz can not only remove free moisture in the gypsum sample, but also allow the removal of the water of crystallization of the gypsum.

### Temperature Changes of a Gypsum Sample During Dielectric Calcination

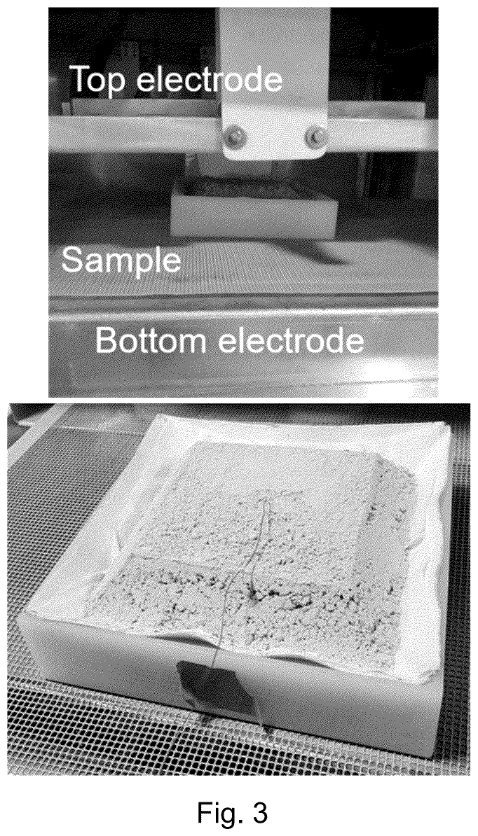

A series of experiments was performed using radio frequency radiation at 40 MHz. FIG. 3 is a photograph of the experimental setup. Radio frequency systems are such that the material to be heated lies between two electrodes generating an alternating electric field, and is part of the system electrical circuit. In these tests, Gypsum powder (3 kg) is placed in a rectangular sample holder (sample dimensions about 12″×12″×3″) and an optical fiber probe is used to measure the temperature in the middle of the gypsum powder bed. The power consumption of the dielectric system was estimated to be in the 4-6 kW range for these tests. Tests of various durations were conducted, generally 30-60 minutes. The mass loss of the sample at the end of the experiments was measured.

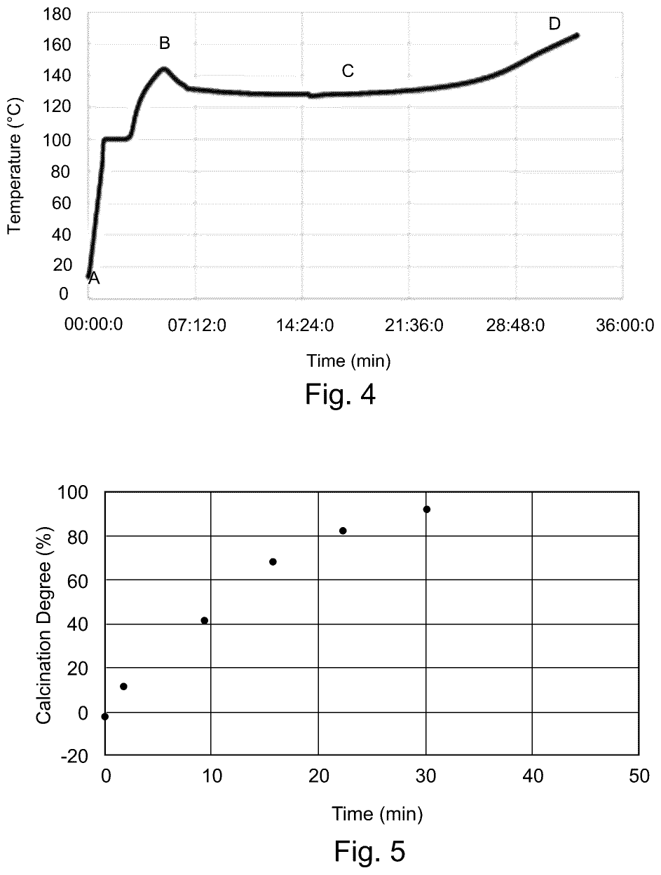

FIG. 4 is a diagram showing the temperature changes of the gypsum sample during dielectric calcination as a function of time. As shown in FIG. 4, during calcination the temperature of the gypsum sample quickly reached about 100° C. and remained there for a short period of time. Without intending to be bound by theory, the present inventors believe that free moisture is being removed from the gypsum sample during this stage. Thereafter, continued radio frequency radiation caused the temperature of the gypsum sample to go up to above 140° C., and then decrease and remain at around 130° C. Without intending to be bound by theory, the present inventors believe that the temperature changes at this stage indicate the occurrence of the dehydration of calcium sulfate dihydrate because an activation energy is needed to initiate the dehydration. FIG. 4 also shows that the temperature rose slowly at a later stage of the radiation. Without intending to be bound by theory, the present inventors believe that the dehydration had been completed at this stage, and the continued radiation simply further increased the temperature of the gypsum sample.

FIG. 5 is a diagram showing the degree of calcination of the gypsum sample as a function of time. As discussed above, the degree of calcination can be calculated by dividing an experimental mass loss of the gypsum sample from calcination with the theoretical mass loss. FIG. 4 shows that the dielectric calcination is complete after about 30 minutes of the radio frequency radiation, with a degree of calcination of about 90%.

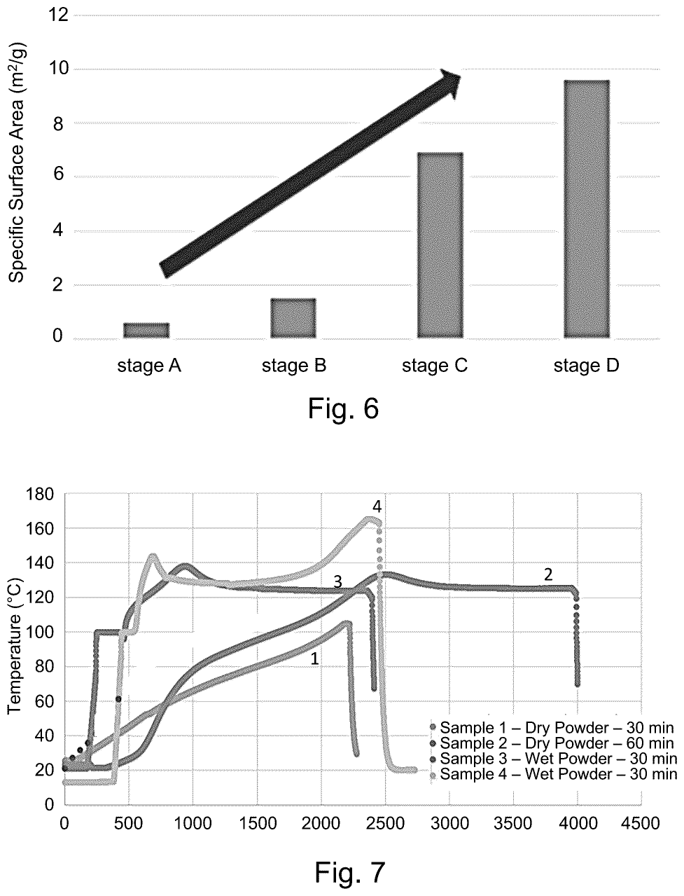

The specific surface area of the sample was measured by the Brunauer-Emmett-Teller (BET) method using a specific surface area measuring device based on nitrogen adsorption. FIG. 6 is a diagram showing the specific surface areas of the gypsum powder in the gypsum sample at different calcination stages during dielectric calcination. Specifically, FIG. 6 shows the specific surface area of the gypsum powder prior to dielectric calcination (stage A identified in FIG. 4); the specific surface area of the gypsum powder when the dehydration of the calcium sulfate dihydrate begins (stage B); the specific surface area of the gypsum powder when the dehydration approaches completion (stage C); and the specific surface area of the gypsum powder after the dehydration is complete (stage D). FIG. 6 indicates that the specific surface areas of the gypsum powder increased as the dielectric calcination progressed. The present inventors believe that such an increase is indicative of an increase of the porosity of the gypsum powder under the influence of the radio frequency radiation.

### Comparisons of Dielectric Calcination of Dry Gypsum Samples and Wet Gypsum Samples

In a separate set of experiments, dielectric calcinations of dry gypsum samples and of wet gypsum samples under radio frequency radiation at 40 MHz were compared. The dry gypsum samples (1 and 2) were dried overnight in a convection oven to remove free moisture to a level of about 0 wt %. The wet gypsum samples (3 and 4) were used as received and had about 7-8 wt % free moisture. The experiments on samples that were 3 kg in scale, and performed as described above.

FIG. 6 is a diagram showing the temperature measured in the samples 1-4 as a function of time during dielectric calcination at 40 MHz. The Table below shows mass changes for the samples.

| | | | | | Initial | |
|---|---|---|---|---|---|---|
| | | Initial | Final | Mass | moisture | |
| Sample | Experiment | mass | mass | change | content | |
| 1 | Dry, 30 min | 7.125 lb | 7.088 lb | 0.52% | ~0 | wt % |
| 2 | Dry, 60 min | 7.242 lb | 6.808 lb | 5.99% | ~0 | wt % |
| 3 | Wet, 60 min | 5.22 lb | 4.376 lb | 16.17% | ~7-8 | wt % |
| 4 | Wet, 60 min | 6.544 lb | 5.164 lb | 21.09% | ~7-8 | wt % |

The data suggest that the temperature rise under radio frequency radiation of the dry samples 1 and 2 progressed slowly. The 30-minute experiment was not sufficient to raise the temperature high enough for significant calcination, while the 60-minute experiment did exhibit roughly 6% mass loss. In contrast, the wet gypsum samples 3 and 4 heated to about 100 C quickly, then progressed to calcination, with about 16% and 21% mass loss respectively (of which 7-8% would have been free moisture). Accordingly, based on the data provided in FIG. 7, the present inventors have determined that the presence of free moisture in gypsum increases the rate of the dehydration of gypsum, thus shortening the calcination time and saving energy.

Various aspects of the disclosure are provided by the following non-limit set of enumerated embodiments, which may be combined in any number and in any combination that is not technically or logically inconsistent.

Embodiment 1. A method of producing a stucco composition, the method comprising: providing a calcium sulfate feed comprising calcium sulfate dihydrate (gypsum); and calcining the calcium sulfate feed using dielectric heating by exposing it to radio frequency radiation at a specific power of at least 15 W/kg calcium sulfate dihydrate in the feed (e.g., for a duration that applies a specific energy dose of at least 0.0027 kW-hr/kg of calcium sulfate dihydrate in the feed), in a radio frequency range up to 900 MHz.

Embodiment 2. The method of embodiment 1, wherein the calcium sulfate feed comprises at least 60 wt % gypsum, e.g., at least 70 wt %, at least 80 wt %, or at least 90 wt % gypsum.

Embodiment 3. The method of embodiment 1, wherein the calcium sulfate feed comprises at least 10 wt % gypsum, e.g., at least 25 wt %, or at least 40 wt % gypsum.

Embodiment 4. The method of any of embodiments 1-3, wherein the calcium sulfate feed comprises free moisture.

Embodiment 5. The method of embodiment 4, wherein the free moisture is present in an amount up to 15 wt %, e.g., up to 10 wt %.

Embodiment 6. The method of embodiment 4, wherein the free moisture is present in an amount in the range of 1-15 wt %, e.g., 1-10 wt %, or 2-15 wt %, or 2-10 wt %, or 3-15 wt %, or 3-10 wt %, or 4-15 wt %, or 4-10 wt %, or 5-15 wt %, or 5-10 wt %.

Embodiment 7. The method of any of embodiments 1-6, wherein the radio frequency range is up to 500 MHz, e.g., no more than 450 MHZ.

Embodiment 8. The method of any of embodiments 1-6, wherein the radio frequency range is up to 100 MHz, e.g., up to 50 MHz.

Embodiment 9. The method of any of embodiments 1-6, wherein the radio frequency range is in the range of 1-900 MHZ, e.g., in the range of 10-900 MHZ, or 20-900 MHZ, or 30-900 MHz, or 35-900 MHZ.

Embodiment 10. The method of any of embodiments 1-6, wherein the radio frequency range is in the range of 1-500 MHZ, e.g., in the range of 10-500 MHZ, or 20-500 MHZ, or 30-500 MHz, or 35-500 MHZ, or 400-500 MHZ, or 430-500 MHZ, or 1-450 MHZ, or 10-450 MHZ, or 20-450 MHz, or 30-450 MHz, or 35-450 MHz, or 400-450 MHZ, or 430-450 MHz.

Embodiment 11. The method of any of embodiments 1-6, wherein the radio frequency range is in the range of 430-436 MHZ, e.g., 432-436 MHZ, or 433-435 MHz, or 433.05-434.79 MHz.

Embodiment 12. The method of any of embodiments 1-6, wherein the radio frequency range is in the range of 1-100 MHZ, e.g., in the range of 10-100 MHz, or 20-100 MHz, or 30-100 MHz, or 35-100 MHz, or 1-50 MHz, or 10-50 MHZ, or 20-50 MHZ, or 30-50 MHZ, or 35-50 MHz.

Embodiment 13. The method of any of embodiments 1-6, wherein the radio frequency range is in the range of 35-45 MHZ, e.g., in the range of 35-43 MHZ, or 35-42 MHZ, or 35-41 MHz, or 37-45 MHz, or 37-43 MHZ, or 37-42 MHz, or 37-41 MHZ, or 39-45 MHZ, or 39-43 MHz, or 39-42 MHZ, or 39-41 MHZ, or 40-45 MHz, or 40-43 MHz, or 40-42 MHZ, or 40-41 MHz, or 40.66-40.7 MHz.

Embodiment 14. The method of any of embodiments 1-6, wherein the radio frequency range is in the range of 25-30 MHZ, e.g., in the range of 25-29 MHz, or 26-30 MHZ, or 26-29 MHz, or 26.957-28.283 MHz.

Embodiment 15. The method of any of embodiments 1-6, wherein the radio frequency range is in the range of 10-15 MHZ, e.g., in the range of 10-14 MHz, or 12-15 MHz, or 12-14 MHz, or 13-15 MHz, or 13-14 MHz, or in the range of 13.553-13.567 MHZ.

Embodiment 16. The method of any of embodiments 1-6, wherein the radio frequency range is in the range of 5-10 MHZ, e.g., in the range of 6-10 MHZ, or 5-7 MHZ, or 6-7 MHZ, or 6.765-6.795 MHz.

Embodiment 17. The method of any of embodiments 1-16, wherein the specific power in the radio frequency range is at least 30 W/kg, e.g., at least 100 W/kg, or at least 200 W/kg, or at least 500 W/kg.

Embodiment 18. The method of any of embodiments 1-17, wherein the calcium sulfate feed is exposed to a specific energy dose in the radio frequency range of at least 0.0027 kW·h/kg of calcium sulfate dihydrate in the feed, e.g., at least 0.005 kW·h/kg, or at least 0.01 kW·h/kg.

Embodiment 19. The method of any of embodiments 1-17, wherein the calcium sulfate feed is exposed to a specific energy dose in the radio frequency range of at least 0.02 kW·h/kg of calcium sulfate dihydrate in the feed, e.g., at least 0.05 kW·h/kg, or at least 0.1 kW·h/kg, or at least 0.2 kW·h/kg, or at least 0.5 kW·h/kg.

Embodiment 20. The method of any of embodiments 1-19, wherein the calcium sulfate feed is exposed to a specific energy dose in the radio frequency range of no more than 3 kW·h/kg of calcium sulfate dihydrate in the feed, e.g., no more than 2 kW·h/kg, or no more than 1.5 kW·h/kg.

Embodiment 21. The method of any of embodiments 1-20, wherein least 10 mol % of the calcium sulfate dihydrate of the calcium sulfate feed is converted to calcium sulfate hemihydrate.

Embodiment 22. The method of any of embodiments 1-20, wherein at least 20 mol %, e.g., at least 30 mol %, or at least 40 mol % of the calcium sulfate dihydrate of the calcium sulfate feed is converted to calcium sulfate hemihydrate.

Embodiment 23. The method of any of embodiments 1-20, wherein at least 50 mol %, e.g., at least 60 mol % of the calcium sulfate dihydrate of the calcium sulfate feed is converted to calcium sulfate hemihydrate.

Embodiment 24. The method of any of embodiments 1-20, wherein at least 70 mol %, e.g., at least 80 mol % of the calcium sulfate dihydrate of the calcium sulfate feed is converted to calcium sulfate hemihydrate.

Embodiment 25. The method of any of embodiments 1-24, wherein at least 5% of crystalline water, e.g., at least 7% of crystalline water is removed from the calcium sulfate dihydrate.

Embodiment 26. The method of any of embodiments 1-24, wherein at least 10% of crystalline water, e.g., at least 15% of crystalline water, or at least 20% of crystalline water is removed from the calcium sulfate feed.

Embodiment 27. The method of any of embodiments 1-24, wherein at least 25% of crystalline water, e.g., at least 30% of crystalline water, at least 35% of crystalline water, or at least 40% of crystalline water is removed from the calcium sulfate feed.

Embodiment 28. The method of any of embodiments 1-24, wherein at least 45%, e.g., at least 50% of crystalline water, at least 55% of crystalline water, at least 60% of crystalline water, or at least 65% of crystalline water is removed from the calcium sulfate feed.

Embodiment 29. The method of any of embodiments 1-28, wherein no more than 75% of crystalline water is removed from the calcium sulfate feed, e.g., no more than 74%, or no more than 73%.

Embodiment 30. The method of any of embodiments 1-29, wherein the calcining reduces the mass of the calcium sulfate feed to provide a stucco composition having a mass of no more than 95% of the mass of the calcium sulfate feed, e.g., no more than 93%, no more than 92%, or no more than 90% of the mass of the calcium sulfate feed.

Embodiment 31. The method of any of embodiments 1-29, wherein calcining reduces the mass of the calcium sulfate feed to provide a stucco composition having a mass of no more 88% of the mass of the calcium sulfate feed, e.g., no more than 87%, or no more than 86% of the mass of the calcium sulfate feed.

Embodiment 32. The method of any of embodiments 1-31, wherein the calcining reduces the mass of the calcium sulfate feed to provide a stucco composition having a mass of no more than 85% of the mass of the calcium sulfate feed, e.g., no more than 84%, no more than 83%, or no more than 82% of the mass of the calcium sulfate feed.

Embodiment 33. The method of any of embodiments 1-31, wherein the calcining reduces the mass of the calcium sulfate feed to provide a stucco composition having a mass of no more than 81% of the mass of the calcium sulfate feed, e.g., no more than 80%, no more than 79%, or no more than 78% of the mass of the calcium sulfate feed.

Embodiment 34. The method of any of embodiments 1-31, wherein the calcining reduces the mass of the calcium sulfate feed to provide a stucco composition having a mass in the range of 75-95% of the mass of the calcium sulfate feed, e.g., 75-93%, or 75-92%, or 75-90%, or 75-88%, or 75-87%, or 75-86%, or 75-85%, or 75-84%, or 75-83%, or 75-82%, or 75-81%, or 75-80%, or 75-79%, or 75-78%, or 77-95%, or 77-93%, or 77-92%, or 77-90%, or 77-88%, or 77-87%, or 77-86%, or 77-85%, or 77-84%, or 77-83%, or 77-82%, or 77-81%, or 77-80%, or 77-79%, or 80-95%, or 80-93%, or 80-92%, or 80-90%, or 80-88%, or 80-87%, or 80-86%, or 80-85%, or 80-84%, or 80-83%, or 80-82% of the mass of the calcium sulfate feed.

Embodiment 35. The method of any of embodiments 1-34, wherein the calcining is performed for a time of at least 5 seconds, e.g., at least 10 seconds, or at least 30 seconds, or at least 1 minute, or at least 5 minutes, or at least 10 minutes, or at least 30 minutes.

Embodiment 36. A production process for a gypsum product, the production process comprising:
providing a stucco composition by the method of any of embodiments 1-35;
hydrating the stucco composition in an aqueous slurry;
allowing the aqueous slurry to set; and
drying the set slurry to form the gypsum product.

We claim:

1. A method of producing a stucco composition, the method comprising:
providing a calcium sulfate feed comprising calcium sulfate dihydrate (gypsum); and
calcining the calcium sulfate feed using dielectric heating by exposing it to radio frequency radiation at a specific power of at least 15 W/kg calcium sulfate dihydrate in the feed (e.g., for a duration that applies a specific energy dose of at least 0.0027 kW-hr/kg of calcium sulfate dihydrate in the feed), in a radio frequency range up to 900 MHz.

2. The method of claim 1, wherein the calcium sulfate feed comprises at least 60 wt % gypsum.

3. The method of claim 1, wherein the calcium sulfate feed comprises free moisture, present in an amount up to 15 wt %.

4. The method of claim 1, wherein the radio frequency range is in the range of 1-1-500 MHz.

5. The method of claim 1, wherein the radio frequency range is in the range 20-100 MHz.

6. The method of claim 1, wherein the radio frequency range is in the range 30-50 MHz.

7. The method of claim 1, wherein the radio frequency range is in the range of 5-10 MHz.

8. The method of claim 1, wherein the specific power in the radio frequency range is at least 30 W/kg.

9. The method of claim 1, wherein the specific power in the radio frequency range is at least 200 W/kg.

10. The method of claim 1, wherein the calcium sulfate feed is exposed to a specific energy dose in the radio frequency range of at least 0.0027 kW·h/kg of calcium sulfate dihydrate in the feed.

11. The method of claim 1, wherein the calcium sulfate feed is exposed to a specific energy dose in the radio frequency range of at least 0.1 kW·h/kg of calcium sulfate dihydrate in the feed.

12. The method of claim 1, wherein the calcium sulfate feed is exposed to a specific energy dose in the radio frequency range of no more than 3 kW·h/kg of calcium sulfate dihydrate in the feed.

13. The method of claim 1, wherein at least 70 mol % of the calcium sulfate dihydrate of the calcium sulfate feed is converted to calcium sulfate hemihydrate.

14. The method of claim 1, wherein at least 5% of crystalline water is removed from the calcium sulfate dihydrate.

15. The method of claim 1, wherein at least 45% of crystalline water is removed from the calcium sulfate feed.

16. The method of claim 1, wherein no more than 75% of crystalline water is removed from the calcium sulfate feed %.

17. The method of claim 1, wherein the calcining reduces the mass of the calcium sulfate feed to provide a stucco composition having a mass of no more than 95% of the mass of the calcium sulfate feed.

18. The method of claim 1, wherein the calcining reduces the mass of the calcium sulfate feed to provide a stucco composition having a mass of no more than 85% of the mass of the calcium sulfate feed.

19. The method of claim 1, wherein the calcining reduces the mass of the calcium sulfate feed to provide a stucco composition having a mass in the range of 75-95% of the mass of the calcium sulfate feed.

20. A production process for a gypsum product, the production process comprising:
providing a stucco composition by the method of claim 1;
hydrating the stucco composition in an aqueous slurry;
allowing the aqueous slurry to set; and
drying the set slurry to form the gypsum product.
